(19) United States
(12) Patent Application Publication
(10) Pub. No.: US 2008/0136240 A1
(43) Pub. Date: Jun. 12, 2008

(54) VEHICLE SEAT

(75) Inventors: Ian Matthews, Koln (DE); Hugues Gall, Orgeval (FR); Oliver Klukowski, Koln (DE); Richard Boudinot, Duesseldorf (DE); Jean-Baptiste Trolle, Koln (DE); Nick Xiromeritis, Koln (DE); David Cooke, Burscheid (DE); Wolfgang Pellenz, Meckenheim (DE); Robin Ndagijimana, Neuss (DE)

Correspondence Address: FOLEY AND LARDNER LLP;SUITE 500, 3000 K STREET NW, WASHINGTON, DC, 20007, US

(73) Assignee: Johnson Controls GmbH

(21) Appl. No.: 11/937,859

(22) Filed: Nov. 9, 2007

Related U.S. Application Data
(63) Continuation of application No. PCT/EP2006/001191, filed on Feb. 10, 2006.

(30) Foreign Application Priority Data
May 5, 2005 (DE) 10 2005 021 482.7

(51) Int. Cl. B60N 2/10; A47C 1/10; A47C 7/02

(52) U.S. Cl. 297/354.1; 297/391; 297/452.18; 297/452.48; 297/452.58

(57) ABSTRACT

A vehicle seat includes a seat part, a backrest, and at least one shell structure comprising a plastic material and having foam padding on a side on which an occupant sits. The at least one shell structure is arranged on frame parts provided on at least one of the seat part and the backrest, the frame parts comprising a metal material.

### CROSS-REFERENCE TO RELATED PATENT APPLICATIONS

The present application is a continuation of International Application No. PCT/EP2006/001191 titled “Vehicle Seat” filed Feb. 10, 2006, which claims priority of German Patent Application No. DE 10 2005 021 482.7 filed May 10, 2005, both of which are incorporated herein by reference in their entireties.

### BACKGROUND OF THE INVENTION

The invention relates to a vehicle seat with a seat part and a backrest, in particular for a motor vehicle, with at least one shell structure consisting of plastics, which is provided with foam padding on the side on which the vehicle occupant sits.

A generic vehicle seat is known from the publication DE 197 57 060 A1. The vehicle seat comprises one respective supporting shell structure made of fiber reinforced thermoplastics for the seat part and backrest which consist of a rear and front half-shell. The half-shells are joined together by high frequency welding. The shell structures are provided with means for fastening inclination adjusters, by means of which the position of the backrest may be adjusted relative to the seat part.

The reinforcing fibers are arranged according to the force transmission directions, in order to provide the required rigidity to the shell structures.

Although such vehicle seats are of low weight, they may only be made at high cost. Moreover, the connection of fitting parts is not without difficulty due to the stress concentrations occurring there.

A vehicle seat with a conventional seating structure is, moreover, disclosed in the published patent application DE 103 38 215 A1, which, for example, may consist of sheet steel sections welded together. Foam padding is directly placed on the sheet metal structure on the side on which the vehicle occupant sits or on spring mats incorporated therein.

Such seats are heavier than the aforementioned embodiment, but may easily be provided with fitting parts by welding, riveting or screwing. The production, however, requires a not inconsiderable cost due to the large number of individual components.

### SUMMARY OF THE INVENTION

One embodiment relates to a vehicle seat comprising a seat part, a backrest, and at least one shell structure comprising a plastic material and having foam padding on a side on which a vehicle occupant sits, wherein the at least one shell structure is arranged on frame parts provided on at least one of the seat part and the backrest, the frame parts comprising a metal material.

Another embodiment relates to a vehicle seat comprising a metal structure with two backrest inclination adjusters, a backrest comprising a U-shaped frame with two projecting ends that are received in the two backrest inclination adjusters, and an elastically deformable shell structure provided on the U-shaped frame on a surface upon which an occupant sits.

### BRIEF DESCRIPTION OF THE DRAWINGS

The figures represent by way of example and schematically various embodiments of the invention, in which:

FIG. 1 shows a first vehicle seat according to the invention,

FIG. 2 shows a vehicle seat according to a further embodiment of the invention,

FIGS. 3-6 show further vehicle seats according to the invention.

### DETAILED DESCRIPTION

One exemplary embodiment provides a vehicle seat of low weight and good mechanical properties, which may be manufactured at a low production cost. The vehicle seat is, moreover, intended to have a particularly slim appearance.

According to an exemplary embodiment, a generic vehicle seat includes at least one shell structure arranged on frame parts of the seat part and/or backrest consisting of metal. The frame parts may consist of sheet steel or light metal, and therefore, absorb the essential working loads and crash loads. Such loads which, for example, in a front impact are introduced into the vehicle seat by the seat belt lock, and the forces occurring in the region of the joint between the backrest and the seat part in a rear impact, are included in the last-mentioned forces. The shell structure is, as a result, considerably unloaded and may therefore, for example, be made by injection-molding an unreinforced or short fiber reinforced thermoplastic, for instance polypropylene. Molded ribs may specifically reinforce parts which are subjected to higher loads. Moreover, the shell structure may be provided with rivet-like deformable pins which are inserted into corresponding bores of the base part and anchor the shell structure thereto. To this end other fastening means, for example screws, may naturally also be provided.

The seat base formed from the frame parts may comprise a first U-shaped frame part associated with the seat part and a second U-shaped frame part associated with the backrest. Said U-shaped frame parts may, for example, be pressed in one piece from a sheet metal part or be produced by casting.

The first and second metallic frame parts comprise, according to an exemplary embodiment of the invention, in the region of the free legs thereof a common rotational axis. In this connection, the shell structure of the seat part and backrest made from plastics may be configured in one piece, said shell structure extending elastically deformably over the region of the rotational axis.

Moreover, the at least one shell structure may have regions which may be elastically arched to influence the seat contour. Such regions may be provided, amongst others, in the backrest as a lumbar support or in the form of pivotable side cheeks. To improve the deformability and to reduce stresses, the relevant regions of the shell structure may be provided with suitable slots and/or recesses.

The mechanical means subjected to high load for the inclination adjustment and/or for arching the shell structure may be anchored in the base part so that the forces exerted on the seat are substantially absorbed by the seat base. Connecting points, which are subjected to lower loads may also be directly provided on the shell structure.

The foam padding may comprise a first upholstery part extending at least partially over the backrest and seat part which, as a result of an anatomically advantageous molding of the shell structure, may be designed to be relatively thin. According to an exemplary embodiment, the upholstery part may, for example, in the region of the occupant support have a thickness of 10 to 50 mm, or alternatively, of only 25 to 35 mm, without an appreciable loss of comfort occurring.

According to an exemplary embodiment, in the region of the headrest, a specific foam cushion is arranged, which for example is fastened in a height adjustable manner to the shell structure of the backrest. Alternatively, the foam cushion may also be anchored to a support connected in a height adjustable manner to the shell structure of the backrest.

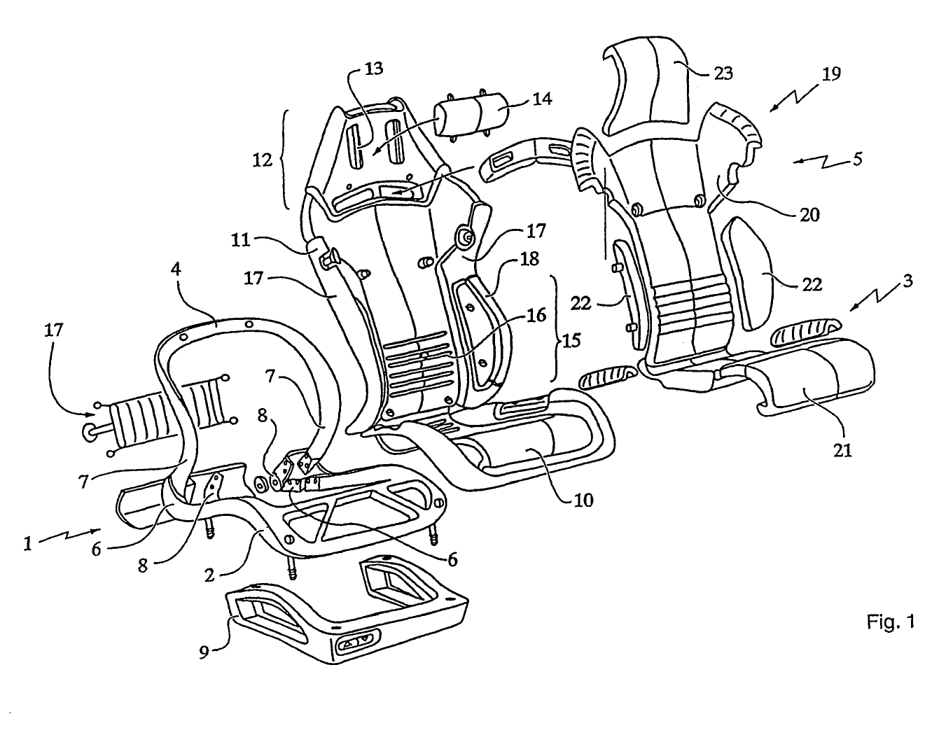

The vehicle seat shown in FIG. 1 includes a seat base 1 with a first frame part 2 which is associated with the seat part 3, and a second frame part 4 which supports the backrest 5 of the vehicle seat. The frame parts 2, 4 are of U-shaped configuration and at the free ends of the legs 6, 7 thereof are joined together in an angularly adjustable manner, respectively by means of an adjustable joint 8. The first frame part 2 is placed on a base 9 also associated with the seat base 1, which is provided with means for the longitudinal adjustment of the seat and is directly connected to the base of the vehicle bodywork.

Two shell structures 10, 11 are arranged on the seat base 1, each of which resting on a frame part 2, 4. The shell structure 11 associated with the backrest 5 is configured to be able to bend in its upper region 12 and is provided with a foam cushion 14 arranged on the upper region 12 in a height-adjustable manner in rails 13. The foam cushion 14 serves as the headrest of the occupant of the seat and supports the head thereof for improving the comfort and safety. As a result of the inclination adjustment of the region 12 of the shell structure 11, the distance between the foam cushion 14 and the head of the occupant of the seat may be altered.

The lower region 15 of the shell structure 11 is provided with a number of horizontally extending slots 16 which locally improve the elastic deformability of the shell structure 11. An adjustable lumbar support 17 inserted into the frame part 4, arches the shell structure 11 in the region of the slot 16 according to the wishes of the occupant of the seat.

The contour of the shell structure 11 may be further adapted to the anatomy of the occupant of the seat by adjusting the side cheeks 17 which are attached in an articulated manner and which also accommodate an airbag module 18 for a side airbag.

As the shell structures 10, 11 therefore already have a very comfortable surface geometry on the side on which the vehicle occupant sits, the foam padding 19 applied thereto may be configured to be relatively thin. In one exemplary embodiment, the upholstery part 20 associated with the backrest 5 has an overall thickness of approximately 30 mm. The comfort achieved thereby also fulfills the requirements for the design of the driver and passenger seats. The upholstery part 21 positioned on the shell structure 10 is specifically made and subsequently sewn to the upholstery part 20. Moreover, foam parts 22, 23 are provided which are arranged in the region of the side cheeks 17 and/or cover the foam cushion 14.

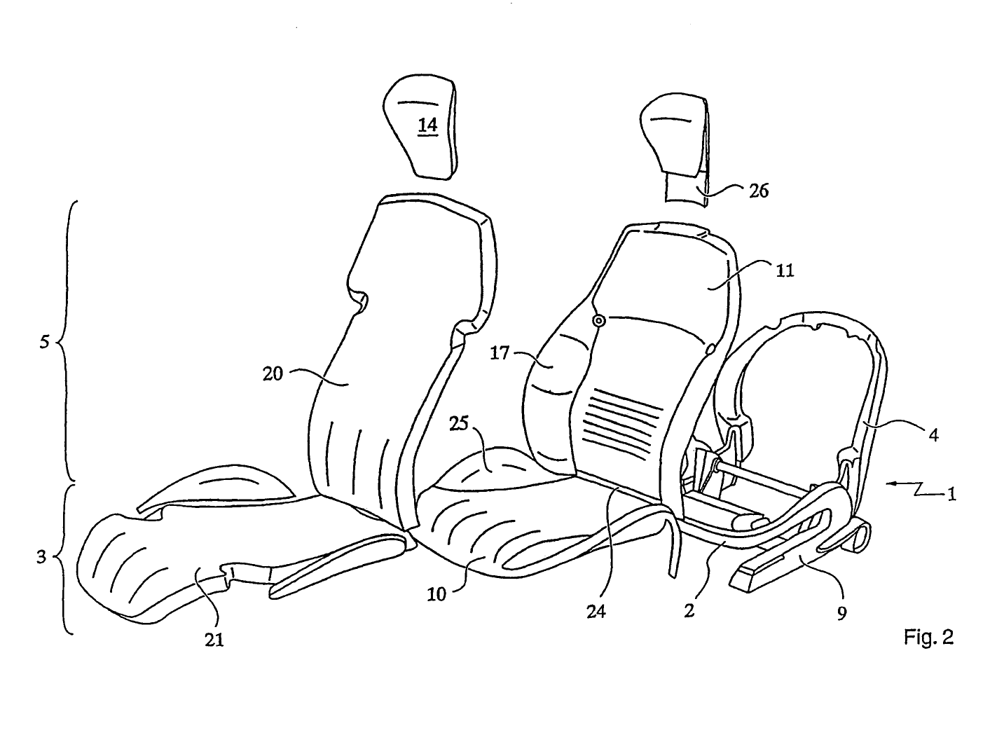

In the exemplary embodiment according to FIG. 2, the shell structures 10, 11 are both directly joined together and, in particular, made in one piece in an injection-molding die. Similarly, the upholstery parts 20, 21 are formed as one piece. During the inclination adjustment of the backrest 5 the shell structure 11 is elastically bent at the junction with the shell structure 10. For this reason the shell structures 10, 11 are only joined together in a linear manner, in a relatively flat-shaped central region 24 but not in the region of their arched side cheeks 17, 25.

According to an exemplary embodiment, the foam cushion 14 is, moreover, arranged on a specific support 26 which, in turn, is inserted into the shell structure 11 in a height-adjustable manner.

In the exemplary embodiment according to FIG. 3, the seat part 3 consists in the conventional manner of a welded metal structure 27 made of sheet steel and a relatively solid cushion 28 made of foamed polyurethane placed directly thereon. The backrest inclination adjusters 29 arranged on the rear region of the metal structure 27 receive the projecting ends of the U-shaped frame part 4 of the backrest 5 in an angularly adjustable manner. The frame part 4 is constructed from two curved tubular pieces 30, 30′ arranged spaced apart from one another, the downwardly projecting ends thereof being connected to the backrest inclination adjusters 29. In the upper region the tubular pieces 30, 30′ are joined together by two vertical tubular uprights 31 which receive the retaining rods 32 of a conventional headrest 33. On the side on which the vehicle occupant sits, the frame part 4 is cladded with an elastically deformable shell structure 11 consisting of plastics, formed according to the body contour and a thin-walled upholstery part 20. On the rear face, cover panels 34 clad the frame part 4.

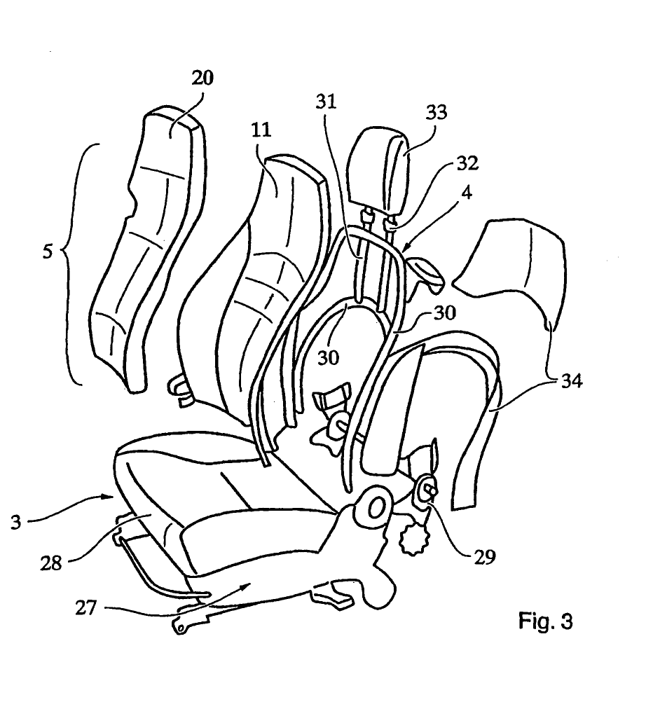

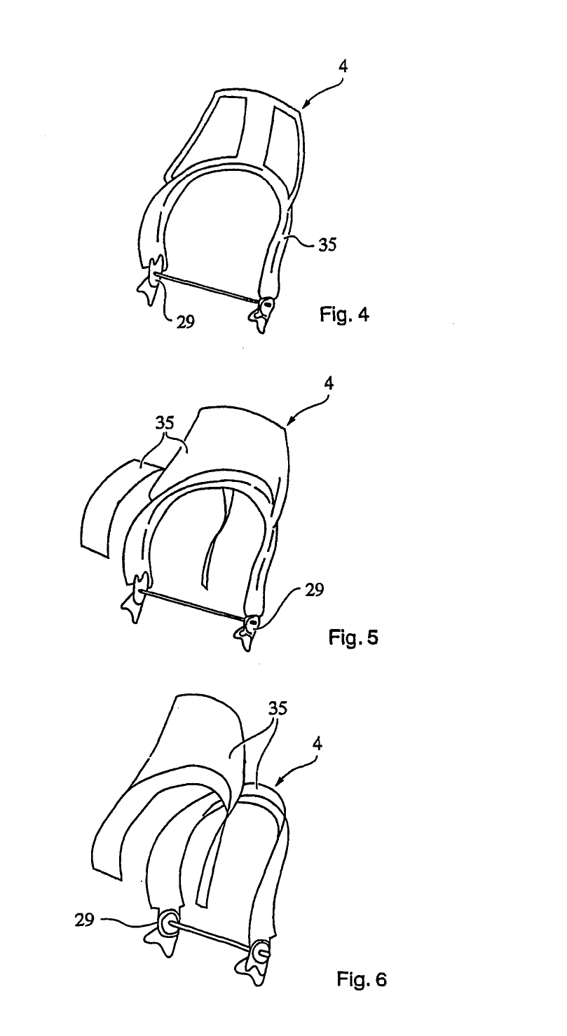

According to other exemplary embodiments, instead of the tubular pieces 30, 30′, the U-shaped frame structure 4 may also be formed by cast or sheet metal stamped parts 35 joined to one another as shown in FIGS. 4 to 6.

What is claimed is:

1. A vehicle seat comprising:
a seat part;
a backrest; and
at least one shell structure comprising a plastic material and having foam padding on a side on which a vehicle occupant sits;
wherein the at least one shell structure is arranged on frame parts provided on at least one of the seat part and the backrest, the frame parts comprising a metal material.

2. The vehicle seat of claim 1 wherein the frame parts comprise a first frame part associated with the seat part wherein the first frame part is of U-shaped configuration and forms a part of a seat base.

3. The vehicle seat of claim 2 wherein the frame parts comprise a second frame part associated with the backrest wherein the second frame part is of U-shaped configuration and forms a part of a seat base.

4. The vehicle seat of claim 3 wherein the first and second frame parts each includes a pair of free legs and a common rotational axis in the region of the free legs.

5. The vehicle seat of claim 4 wherein the at least one shell structure is provided on the seat part and the backrest and wherein the at least one shell structure is configured in one piece and extends elastically and deformably over the common rotational axis.

6. The vehicle seat of claim 1 wherein the at least one shell structure comprises surface regions that may be elastically deformed to influence a contour of the vehicle seat.

7. The vehicle seat of claim 6 further comprising:
mechanical means for the inclination adjustment and/or for arching the shell structure are anchored in a seat base;

8. The vehicle seat of claim 1 wherein the foam padding comprises a first upholstery part extending at least partially over the backrest and the seat part.

9. The vehicle seat of claim 8 wherein the first upholstery part in a region where an occupant is supported has a thickness of approximately 10 mm to 50 mm.

10. The vehicle seat of claim 1 wherein a foam cushion is arranged in a region of a headrest.

11. The vehicle seat of claim 10 wherein the at least one shell structure is provided on the backrest and the foam cushion is fastened to a support connected in a height-adjustable manner to the at least one shell structure of the backrest.

12. The vehicle seat of claim 1 wherein the at least one shell structure consists of plastics and the frame parts consist of metal.

13. A vehicle seat comprising:
a seat part comprising a metal structure with two backrest inclination adjusters;
a backrest comprising a U-shaped frame with two projecting ends that are received in the two backrest inclination adjusters; and
an elastically deformable shell structure provided on the U-shaped frame on a surface upon which an occupant sits.

14. The vehicle seat of claim 13 wherein the U-shaped frame comprises a pair of tubular-shaped members that are spaced apart from each other.

15. The vehicle seat of claim 13 wherein the U-shaped frame is a cast structure.

16. The vehicle seat of claim 13 wherein the metal structure is a sheet steel structure.

17. The vehicle seat of claim 13 further comprising:
two vertical tubular members coupled to the U-shaped frame and configured to receive a headrest.

18. The vehicle seat of claim 13 further comprising:
at least one cover panel provided on the U-shaped frame on a rear surface opposite the surface upon which an occupant sits.

19. The vehicle seat of claim 13 wherein the seat part comprises a foamed polyurethane cushion.

20. The vehicle seat of claim 13 further comprising:
an upholstery part provided on the shell structure.
